(19) United States
(12) Patent Application Publication
(10) Pub. No.: US 2009/0238962 A1
(43) Pub. Date: Sep. 24, 2009

(54) METHOD OF PRODUCING OPTICAL FILM

(75) Inventors: Kazuya Hada, Osaka (JP); Ikuo Kawamoto, Osaka (JP); Hideyuki Yonezawa, Osaka (JP); Kazuki Tsuchimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/303,136

(22) PCT Filed: May 17, 2007
(86) PCT No.: PCT/JP2007/060138

§ 371 Date: Apr. 24, 2009

(30) Foreign Application Priority Data
Jun. 6, 2006 (JP) 2006-157215

(51) Int. Cl. B05D 5/06

(52) U.S. Cl. 427/162

(57) ABSTRACT

In a method of producing an optical film including: a rubbing treatment step of rubbing a surface of a long plastic film F by a rubbing roll 4 on which a raised fabric is wound; an applying step of applying liquid crystalline molecules on the surface of the film after the rubbing treatment step; and a fixing step of fixing the applied liquid crystalline molecules, in which in the rubbing treatment step, the film is conveyed while being supported by a conveyance belt 3 having a metal surface, and a backup roll mechanism 5 that supports a bottom face of the conveyance belt is provided. The backup roll mechanism has a plurality of backup rolls 51 each rotating along the conveyance direction of the conveyance belt, and each backup roll is disposed directly below the rubbing roll, along a straight line that is approximately parallel with a rotation axis of the rubbing roll.

### TECHNICAL FIELD

The present invention relates to a method of producing an optical film used for optical compensation and antireflection in a liquid crystal display or the like. In particular, the present invention relates to a production method capable of producing an optical film having uniform optical characteristics with low cost.

### BACKGROUND ART

Conventionally, various kinds of optical devices that are produced by applying a liquid crystal material and making it be oriented on a surface of a base material are known. In such a production process of optical devices, generally, a rubbing treatment for rubbing a surface of the base material in one direction, for example, with a raised fabric is conducted in order to make the liquid crystal material be oriented on the surface of the base material. For example, when the optical device is a liquid crystal cell, the rubbing treatment is conducted in a unit of a glass substrate as the base material. However, in the case of an optical device (optical film) using a plastic film as the base material, it is overwhelmingly advantageous in production efficiency and thus in cost to continuously conduct the rubbing treatment in a so-called roll-to-roll method using a long plastic film rather than conducting the rubbing treatment for every cut film.

Therefore, as a method of continuously conducting a rubbing treatment on a long film by the aforementioned roll-to-roll method in production of an optical film, various methods have been conventionally proposed.

For example, Patent Document 1 proposes a rubbing method featured in that while a long film is conveyed by a conveyance belt having a mirror-finished metal surface, a rubbing treatment is conducted on a surface of the film with a rubbing roll disposed on the conveyance belt.

Patent Document 2 proposes a rubbing method featured in that while a long film is conveyed continuously between a rubbing roll and a backup roll arranged to be opposed to the rubbing roll, a rubbing treatment is conducted on a surface of the film by the rubbing roll.

On the other hand, as a base material on which a rubbing treatment is to be conducted in producing an optical film, a material having a straight-chain structure, for example, a triacetyl cellulose (TAC) film or a polyvinyl alcohol (PVA) film is generally used. As a liquid crystal material to be applied on a surface of the rubbed base material (film), liquid crystalline molecules having one or more functional group(s) are used. Then a solution of liquid crystalline molecules dissolved in an appropriate organic solvent or the like is applied, then dried and oriented on a surface of the rubbed film, and then cross-linked and fixed by exposure to appropriate light such as ultraviolet rays. Thus, an optical film is produced.

### [Patent Document 1] Japanese Patent Application Laid-open Publication No. 2004-170454

### [Patent Document 2] Japanese Patent Application Laid-open Publication No. 6-110059

### DISCLOSURE OF THE INVENTION

However, for example, when a rubbing treatment is conducted in a continuous manner by a roll-to-roll method using a long TAC film as a base material, blocking (the phenomenon that base materials are closely adhered to each other without having any optical interface) may occur in the base material wound on a roll before subjected to the rubbing treatment.

In the base material as described above, since the surface condition of the part where blocking occurs changes, when the base material is subjected to the rubbing treatment, orientation characteristics vary between the part where blocking occurs and the remaining part and a domain arises in the liquid crystal molecules, so that a uniform orientation state may not be obtained. For example, when the optical film to be produced is a retardation film for use in a liquid crystal display, since the uniformity in the screen is crucial, almost no product value is obtained with a retardation film having such a nonuniform orientation state.

In order to obtain uniform orientation characteristics for the base material where blocking occurs, for example, conceivable is the measure of increasing the pushing amount of the rubbing roll in the method described in Patent Document 1. However, the method described in Patent Document 1 faces the problem that the rubbing treatment can not be conducted in a stable condition due to the influences of looseness of the conveyance belt, and in turn, looseness of the film, or the like, when the pushing amount is increased excessively, because there is no backup roll that supports the bottom face of the conveyance belt.

It is also conceivable that uniform orientation characteristics can be obtained for the base material where blocking occurs by increasing the pushing amount of the rubbing roll in the method described in Patent Document 2. However, in the method described in Patent Document 2, since only one backup roll that rotates along the conveyance direction of a film is provided, there is a problem that the rubbing treatment cannot be conducted in a stable condition due to the influence of looseness of the film or the like particularly when the rotation axis of the rubbing roll is inclined from a perpendicular direction with respect to the conveyance direction of the film.

In order to solve such a problem, it is conceivable to support the bottom face of the conveyance belt supporting the film, by a plurality of bar-like backup rolls that are arranged approximately parallel with each other, and rotate along the conveyance direction of the conveyance belt. However, there still remains the problem that influences of the looseness of the conveyance belt, and in turn, the looseness of the film cannot be sufficiently avoided, particularly when the rotation axis of the rubbing roll is inclined from a perpendicular direction with respect to the conveyance direction of the film.

The present invention was devised to solve the problems of conventional techniques as described above, and it is an object of the present invention to provide a production method capable of producing an optical film of low cost and having uniform optical characteristics even when a base material that will cause blocking is used and a rotation axis of a rubbing roll is inclined from a perpendicular direction with respect to a conveyance direction of the film.

In order to solve the above-mentioned problems, the present invention provides a method of producing an optical film comprising a rubbing treatment step of rubbing a surface of a long plastic film by a rubbing roll having a rotation axis inclined from a perpendicular direction with respect to a conveyance direction of the long plastic film, an applying step of applying liquid crystalline molecules on the surface of the long plastic film after the rubbing treatment step, and a fixing step of fixing the applied liquid crystalline molecules, wherein in the rubbing treatment step, the long plastic film is conveyed while being supported by a conveyance belt having a metal surface, and a backup roll mechanism that supports a bottom face of the conveyance belt supporting the long plastic film is provided, the backup roll mechanism has a plurality of backup rolls each rotating along the conveyance direction of the conveyance belt, and each of the plurality of backup rolls is disposed directly below the rubbing roll, along a straight line that is approximately parallel with the rotation axis of the rubbing roll.

According to the present invention, since it is possible to conduct a rubbing treatment on a long plastic film in a continuous manner by the roll-to-roll method, an optical film can be produced with low cost. Further, according to the present invention, since the backup roll mechanism that supports the bottom face of the conveyance belt supporting a long plastic film has a plurality of backup rolls disposed directly below the rubbing roll, along the straight line that is approximately parallel with a rotation axis of the rubbing roll, even when the rotation axis of the rubbing roll is inclined from the perpendicular direction with respect to the conveyance direction of the conveyance belt, each of the backup rolls is disposed directly below the inclined rubbing roll via the long plastic film and the conveyance belt. Further, according to the present invention, since each of the backup rolls rotates along the conveyance direction of the conveyance belt (conveyance direction of the long plastic film), rotation of each of the backup rolls will not inhibit movement of the conveyance belt in the conveyance direction, and thus conveyance of the long plastic film. Therefore, even when the pushing amount of the rubbing roll is increased while the rotation axis of the rubbing roll is inclined from the perpendicular direction with respect to the conveyance direction of the conveyance belt, the flatness of the conveyance belt is improved and looseness is less likely to occur, and movement of the conveyance belt will not be inhibited, so that the rubbing treatment can be conducted in a stable condition. As a result, it is possible to impart uniform orientation characteristics to the long plastic film, and thus to produce an optical film having uniform optical characteristics.

Preferably, the backup roll mechanism further includes a pedestal part disposed along a straight line that is approximately parallel with the rotation axis of the rubbing roll, and a plurality of supporting parts borne on the pedestal part in a rotatable manner about a normal of a surface of the conveyance belt, and each of the plurality of backup rolls is borne on each of the plurality of supporting part in a rotatable manner along the conveyance direction of the conveyance belt.

According to such a preferred configuration, even when the rotation axis of the rubbing roll is inclined from the perpendicular direction with respect to the conveyance direction of the conveyance belt, by inclining the pedestal part constituting the backup roll mechanism in a similar manner (namely, the pedestal part is inclined to follow the straight line that is approximately parallel with the rotation axis of the inclined rubbing roll), the supporting part borne on the pedestal part will naturally rotate so that the back roll borne by the supporting part is oriented to rotate along the conveyance direction of the conveyance belt in association with the movement of the conveyance belt (by frictional force imparted from the bottom face of the conveyance belt). In other words, even when the inclination angle of the rubbing roll is not fixed, and a setting value of the inclination angle is changed, it is possible to make each of the backup rolls be disposed directly below the rubbing roll and rotate along the conveyance direction of the conveyance belt only by changing the inclination angle of the pedestal part similarly to that of the rubbing roll.

Further preferably, the backup roll mechanism further includes a coupling mechanism that couples the rubbing roll and the pedestal part, in such a manner that the pedestal part is inclined accordingly when the rotation axis of the rubbing roll is inclined from a perpendicular direction with respect to the conveyance direction of the conveyance belt.

According to such a preferred configuration, since there is provided the coupling mechanism that couples the rubbing roll and the pedestal part in such a manner that when the rotation axis of the rubbing roll is inclined from the perpendicular direction with respect to the conveyance direction of the conveyance belt, the pedestal part is also inclined in association with this, an advantage arises that setting is greatly facilitated compared to the configuration in which the rubbing roll and the backup roll mechanism (pedestal part) are individually inclined.

In addition, it is preferred that the rotation axis of the rubbing roll is inclined at an angle of more than 0° and not more than 45° with respect to a perpendicular direction of the conveyance direction of the long plastic film.

Here, as for the plurality of backup rolls, when a center-to-center distance in the rotation axis direction between neighboring backup rolls is set to be larger than 200 mm, unevenness in orientation may occur and appearance defect may arise due to decrease in flatness of the conveyance belt. On the other hand, when the center-to-center distance is set to be smaller than 60 mm, the width of the member supporting the backup rolls is small, and the strength for stably retaining the backup rolls is reduced, so that the flatness of the conveyance belt decreases. Therefore, for securely avoiding the problem as described above, a center-to-center distance in the rotation axis direction of neighboring backup rolls is set at preferably 60 mm or more and 200 mm or less, more preferably 70 mm or more and 150 mm or less.

When the width in the rotation axis direction of each of the plurality of backup rolls is set to be smaller than 20 mm, there arises the possibility that the conveyance belt is damaged by frictional heat. On the other hand, when the width is set to be larger than 150 mm, it becomes difficult to dispose a backup roll directly below the rubbing roll when the rotation axis of the rubbing roll is inclined from the perpendicular direction with respect to the conveyance direction of the long plastic film, so that unevenness in orientation may occur and appearance defect may arise due to decrease in flatness of the conveyance belt. Therefore, for securely avoiding the problem as described above, a width in the rotation axis direction of each of the plurality of backup rolls is set at preferably 20 mm or more and 150 mm or less, more preferably 25 mm or more and 70 mm or less.

The production method of the present invention is particularly useful when the long plastic film is a triacetyl cellulose film.

Also, it is preferred that the triacetyl cellulose film is saponified.

By subjecting the triacetyl cellulose film to a saponification treatment, it is possible to prevent occurrence of the phenomenon that the layer of liquid crystalline molecules fixed on a surface of the triacetyl cellulose film is broken (so-called blocking) when the optical film produced by the production method of the present invention is wound in a roll form.

It is preferred that a raised fabric is wound on the rubbing roll.

It is preferred that the raised fabric is, for example, any one of rayon, cotton and a mixture thereof.

Further, a thickness of the conveyance belt is made preferably 0.5 mm to 2.0 mm (more preferably 0.7 to 1.5 mm) to prevent the belt from loosening easily while imparting flexibility.

According to the method of producing an optical film of the present invention, it is possible to produce an optical film of low cost and having uniform optical characteristics even when a rotation axis of the rubbing roll is inclined from the perpendicular direction with respect to the conveyance direction of the film. This owes to improvement in flatness of the conveyance belt by arranging the plurality of backup rolls directly below the rubbing roll in such a manner that the center-to-center distance in the rotation axis direction thereof is a predetermined value.

### BRIEF DESCRIPTION OF THE DRAWINGS

FIG. 1 is a front view showing a schematic configuration of a rubbing treatment apparatus for executing a rubbing treatment step in a production method of an optical film according to one embodiment of the present invention.

FIGS. 2A to 2C are views showing a schematic configuration of the backup roll mechanism shown in FIG. 1, in which FIG. 2A is a plan view, FIG. 2B is a perspective view in the vicinity of the backup roll, and FIG. 2C is a view seen from the conveyance direction of the film.

FIG. 3 is a perspective view showing a schematic configuration of a rubbing treatment apparatus according to the comparative example.

FIGS. 4A and 4B show examples of pictures of appearance of triacetyl cellulose films to which the rubbing treatment is conducted in the example and the comparative example of the present invention.

### BEST MODE FOR CARRYING OUT THE INVENTION

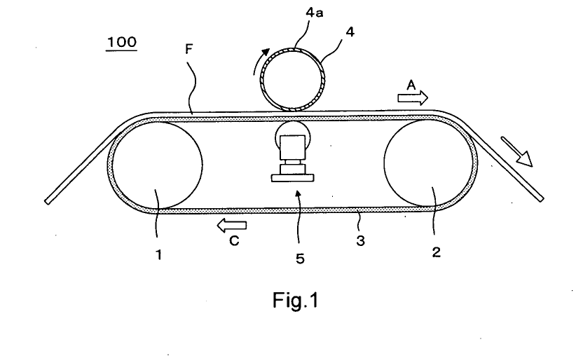

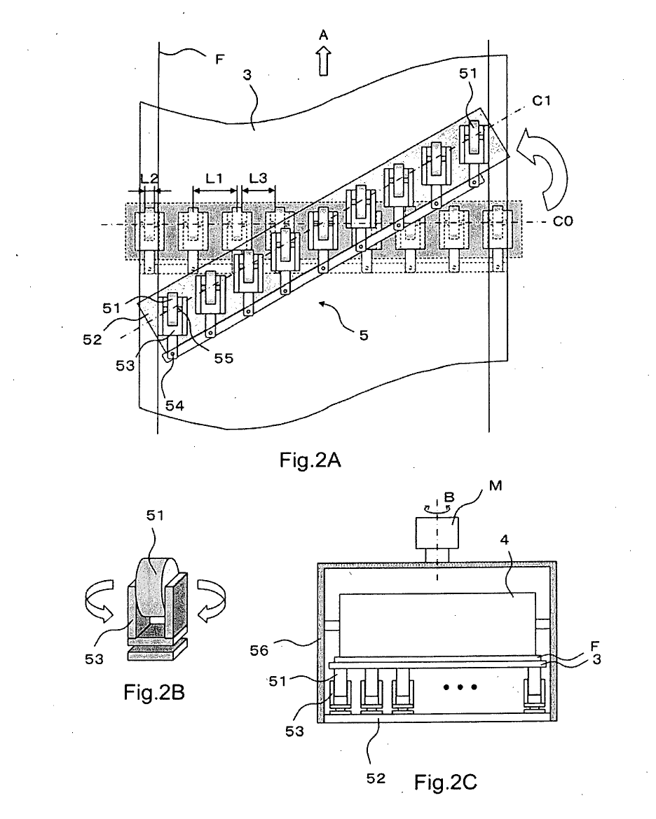

In the following, one embodiment of the present invention will be explained with reference to attached drawings. FIG. 1 is a front view showing a schematic configuration of a rubbing treatment apparatus for executing a rubbing treatment step in a production method of an optical film according to one embodiment of the present invention. FIGS. 2A to 2C are views showing a schematic configuration of the backup roll mechanism shown in FIG. 1, in which FIG. 2A is a plan view, FIG. 2B is a perspective view in the vicinity of the backup roll, and FIG. 2C is a view seen from the conveyance direction of the film. As shown in FIG. 1, a rubbing treatment apparatus 100 according to the present embodiment includes driving rolls 1 and 2, a conveyance belt 3 of endless track, suspended between the driving rolls 1 and 2, for supporting and conveying a long plastic film F, a rubbing roll 4 disposed above the conveyance belt 3 so as to be able to move up and down in the up-and-down direction, and a backup roll mechanism 5 that supports the bottom face of the conveyance belt 3 supporting the long plastic film F. Before and after the rubbing apparatus 100, an appropriate electrostatic removing device or dust repellent device may be provided as necessary.

The conveyance belt 3 has a mirror-finished metal surface on the side where it supports the long plastic film F (the entire conveyance belt 3 may be made of a metal). As such a metal, various metal materials including copper and steel may be used, however, from the viewpoints of strength, hardness and durability, it is more preferred to use stainless steel. In order to ensure adhesiveness with the long plastic film F, the degree of mirror finishing is preferably 0.02 μm or less, and more preferably 0.01 μm or less in surface roughness (Ra). In order to prevent the long plastic film F from loosening, it is necessary to prevent the conveyance belt 3 supporting the long plastic film F from loosening. In light of the necessity of imparting a certain degree of flexibility for being suspended between the driving rolls 1 and 2 while preventing loosening of the conveyance belt 3, the thickness of the conveyance belt 3 is preferably 0.5 mm to 2.0 mm, and more preferably 0.7 mm to 1.5 mm. Further, in consideration of the tension strength of the conveyance belt 3 while preventing loosening of the conveyance belt 3, the tension imparted to the conveyance belt 3 is preferably 0.5 to 20 kgw/mm², and more preferably 2 to 15 kgw/mm².

On the outer circumferential face of the rubbing roll 4, a raised fabric 4a is wound. The material and the shape of the raised fabric may be appropriately selected depending on the material of the long plastic film F to which the rubbing treatment is conducted. In general, as the raised fabric 4a, rayon, cotton or a mixture thereof may be applied. A rotation axis of the rubbing roll 4 according to the present embodiment is configured in such a manner that it can be inclined from the perpendicular direction (for example, the inclination angle is more than 0° and not more than 45°) with respect to the conveyance direction of the long plastic film F (the direction denoted by the arrow A in FIG. 1), or it can be at an arbitrary axial angle with respect to the long side of the long plastic film F. The rotation direction of the rubbing roll 4 may be appropriately selected depending on the condition of the rubbing treatment. The outer diameter of the rubbing roll 4 (including the raised fabric 4a) is set at preferably 130 mm or more and 170 mm or less (more preferably 140 mm or more and 160 mm or less).

As shown in FIG. 2A, the backup roll mechanism 5 has a plurality of backup rolls 51 each rotating along the conveyance direction of the conveyance belt 3 (the direction denoted by the arrow A in FIG. 2A). Each of the backup rolls 51 is disposed directly below the rubbing roll 4, along the straight line that is approximately parallel with the rotation axis of the rubbing roll 4.

Since the backup roll mechanism 5 that supports the bottom face of the conveyance belt 3 supporting a long plastic film F has a plurality of backup rolls 51 disposed directly below the rubbing roll 4, along the straight line that is approximately parallel with a rotation axis of the rubbing roll 4, even when the rotation axis of the rubbing roll 4 is inclined from the perpendicular direction with respect to the conveyance direction of the conveyance belt 3 (for example, a straight line C1 in FIG. 2A is the rotation axis of the rubbing roll 4), each of the backup rolls 51 is disposed directly below the inclined rubbing roll 4 via the long plastic film F and the conveyance belt 3. Further, since each of the backup rolls 51 rotates along the conveyance direction of the conveyance belt 3 (conveyance direction of the long plastic film F), rotation of each of the backup rolls 51 will not inhibit movement of the conveyance belt 3 in the conveyance direction, and thus conveyance of the long plastic film F. Therefore, even when the pushing amount of the rubbing roll 4 is increased while the rotation axis of the rubbing roll 4 is inclined from the perpendicular direction with respect to the conveyance direction of the conveyance belt 3, the flatness of the conveyance belt 3 is improved and looseness is less likely to occur, and movement of the conveyance belt 3 will not be inhibited, so that the rubbing treatment can be conducted in a stable condition. As a result, it is possible to impart uniform orientation characteristics to the long plastic film F, and thus to produce an optical film having uniform optical characteristics.

As a preferred configuration, the backup roll mechanism 5 of the present embodiment further includes a pedestal part 52 disposed along a straight line that is approximately parallel with the rotation axis of the rubbing roll 4, and a plurality of supporting parts 53 borne on the pedestal part 52 in a rotatable manner about a normal of a surface of the conveyance belt 3, and each of the backup rolls 51 is borne on each of the supporting parts 53 in a rotatable manner along the conveyance direction of the conveyance belt 3. To be more specific, the supporting part 53 of the present embodiment is borne on the pedestal part 52 by an axial member 54, and is rotatable about the axial member 54. The backup roll 51 of the present embodiment is borne on the supporting part 53 by an axial member 55, and is rotatable about the axial member 55.

According to such a preferred configuration, even when the rotation axis of the rubbing roll 4 is inclined from the perpendicular direction (direction of a straight line C0 in FIG. 2A) with respect to the conveyance direction of the conveyance belt 3, by inclining the pedestal part 52 constituting the backup roll mechanism 5 in a similar manner (namely, the pedestal part 52 is inclined to follow the straight line that is approximately parallel with the rotation axis of the inclined rubbing roll 4), the supporting part 53 borne on the pedestal part 52 will naturally rotate so that the back roll 51 borne by the supporting part 53 is oriented to rotate along the conveyance direction of the conveyance belt 3 in association with the movement of the conveyance belt 3 (by frictional force imparted from the bottom face of the conveyance belt 3). In other words, as the present embodiment, even when the inclination angle of the rubbing roll 4 is not fixed, and a setting value of the inclination angle is changed, it is possible to make each of the backup rolls 51 be disposed directly below the rubbing roll 4 and rotate along the conveyance direction of the conveyance belt 3 only by changing the inclination angle of the pedestal part 52 similarly to that of the rubbing roll 4.

As a preferred configuration, the backup roll mechanism 5 according to the present embodiment further includes a coupling mechanism 56 that couples the rubbing roll 4 and the pedestal part 52, in such a manner that the pedestal part 52 is inclined accordingly when the rotation axis of the rubbing roll 4 is inclined from a perpendicular direction with respect to the conveyance direction of the conveyance belt 3, as shown in FIG. 2C. To be more specific, the coupling mechanism 56 according to the present embodiment supports the rubbing roll 4 so that it is rotatable about the rotation axis and movable in the up-and-down direction, and is formed into a frame member having an approximately reverse U-shaped cross section that supports the pedestal part 52 and is rotatable in the direction of the arrow B in FIG. 2C by a motor M attached to its top. As the coupling mechanism 56 rotates in the direction of the arrow B in FIG. 2C by the motor M, the rubbing roll 4 and the pedestal part 52 supported by the coupling mechanism 56 rotate (incline) in the same direction by the same angle. Therefore, it is possible to make settings very easily compared to the case where the rubbing roll 4 and the pedestal part 52 are inclined individually. In the present embodiment, the configuration for automatically rotating the coupling mechanism 56 by using the motor M is explained, however, the present invention is not limited to this, but a configuration where the coupling mechanism 56 is manually rotated may also be employed.

In addition, as a preferred configuration of the present embodiment, a center-to-center distance L1 in the rotation axis direction of neighboring backup rolls 51 (see FIG. 2A) is set at 60 mm or more and 200 mm or less (more preferably 70 mm or more and 150 mm or less). Further, a width in the rotation axis direction of each of backup rolls 51 (see FIG. 2A) is set at 20 mm or more and 150 mm or less (more preferably 25 mm or more and 70 mm or less). An interval distance L3 between the neighboring backup rolls 51 (see FIG. 2A) is set at 40 mm or more and 60 mm or less (more preferably 45 mm or more and 55 mm or less), and the outer diameter of each of the backup rolls 51 is set at 70 mm or more and 110 mm or less (more preferably 80 mm or more and 100 mm or less), and the length of the pedestal part 52 is set at 1500 mm or more and 2500 mm or less (but set at a value larger than the width of the conveyance belt 3).

In conducting a rubbing treatment on the long plastic film F by using the rubbing apparatus 100 having the configuration as described above, a leading end of the long plastic film F wound on a predetermined roll (not shown) is supplied onto the conveyance belt 3 via a plurality of conveyance rolls (not shown). Then, by rotationally driving the driving rolls 1 and 2, the conveyance belt 3 moves in the direction of the arrow C in FIG. 1, and in association with this, the long plastic film F is also conveyed with the conveyance belt 3 and subjected to the rubbing treatment by the rubbing roll 4.

As for the long plastic film F to which the production method according to the present embodiment is applied, the material thereof is not particularly limited in so far as it is imparted with a function of allowing liquid crystalline molecules applied on a surface to be oriented as will be described later by conducting the rubbing treatment on a surface thereof or on an orientation layer formed on the surface.

For example, as the long plastic film F, films formed of a polyolefin such as triacetyl cellulose (TAC), polyethylene, polypropylene, or poly(4-methylpentene-1), polyimide, polyimide amide, polyether imide, polyamide, polyether ether ketone, polyether ketone, polyketone sulfide, polyether sulfone, polysulfone, polyphenylene sulfide, polyphenylene oxide, polyethylene terephthalate, polybutylene terephthalate, polyethylene naphthalate, polyacetal, polycarbonate, polyarylate, acrylic resin, polyvinyl alcohol, polypropylene, cellulose-based plastics, epoxy resin, phenol resin and the like may be recited. Also, a laminate of the above film, on which a stretched film having been subjected to stretching treatment such as uniaxial stretching and having birefringence is overlaid as an orientation layer, may also be used as the long plastic film F.

However, the production method according to the present embodiment is particularly useful for a film which is susceptible to blocking, for example, for a triacetyl cellulose film. Further, in order to prevent the phenomenon that a layer of liquid crystalline molecules fixed on the surface of the triacetyl cellulose film is broken when the optical film produced by the production method according to the present embodiment is wound in a roll form, it is preferred to saponify the triacetyl cellulose film.

In view of the specification of the apparatus or the like, it is general that the conveyance speed of the long plastic film F is in the range of 1 to 50 m/min, preferably 1 to 10 m/min, and the rotation speed of the rubbing roll 4 is in the range of 1 to 3000 rpm, preferably 500 to 2000 rpm, and the pushing amount of the rubbing roll 4 is in the range of 100 to 2000 μm, preferably 100 to 1000 μm. The above term “pushing amount of the rubbing roll 4” means an amount (positional variation) by which the rubbing roll 4 is pushed toward the long plastic film F from an original point (0 point) that is the point where a tip of the raised fabric wound on the rubbing roll 4 comes into contact with a surface of the long plastic film F first, when the position of the rubbing roll 4 with respect to the surface of the long plastic film F is varied.

On the surface of the long plastic film F on which the rubbing treatment is made as described above, liquid crystalline molecules are applied, and the applied liquid crystalline molecules are cured or solidified to thereby produce an optical film.

In applying liquid crystalline molecules, a solution in which a liquid crystalline compound is dissolved is generally used. As the liquid crystalline molecules dissolved in the solution, a liquid crystal polymer, a liquid crystal prepolymer, a liquid crystal monomer and the like are appropriately used.

When a liquid crystal polymer is used, after applying the liquid crystal polymer solution on a surface of the long plastic film F, the liquid crystal polymer solution is heated to a temperature in a region where it shows a liquid crystal phase or higher, and dried, and then rapidly cooled to room temperature in the condition that it shows a liquid crystal phase, and thereby the liquid crystal state showing optical anisotropy can be fixed.

When a liquid crystal prepolymer or a liquid crystal monomer is used, after the solution thereof is applied on a surface of the long plastic film F, the solution is heated to a temperature in a region where it shows a liquid crystal phase or higher, and dried, and then rapidly cooled to a temperature where it shows a liquid crystal phase, and allowed to cross-link by exposure to light such as ultraviolet rays, and thereby the liquid crystal state showing optical anisotropy can be fixed.

As the liquid crystal monomer, for example, a monomer shown by any of the following chemical formulas (1) to (16) may be selected.

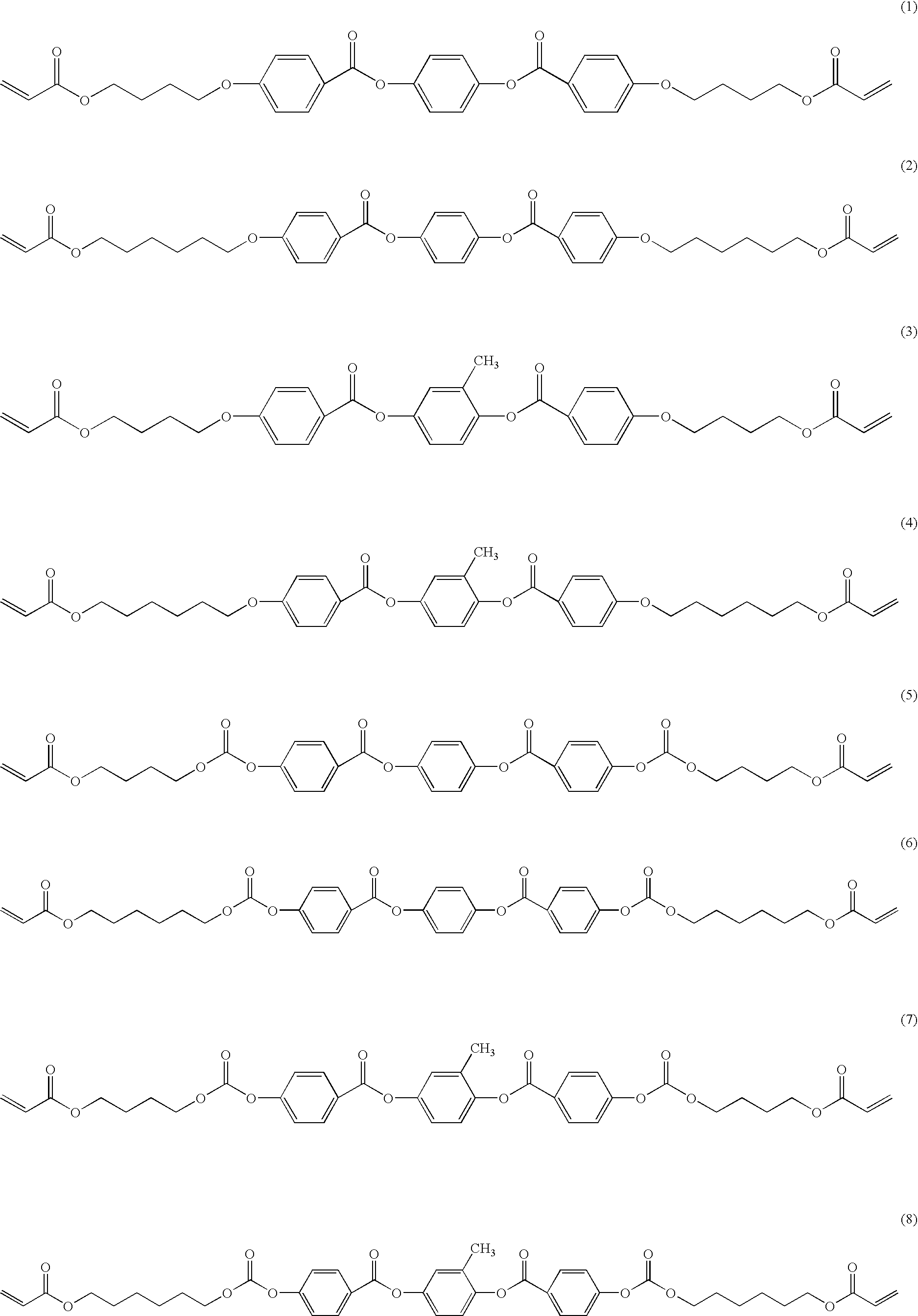

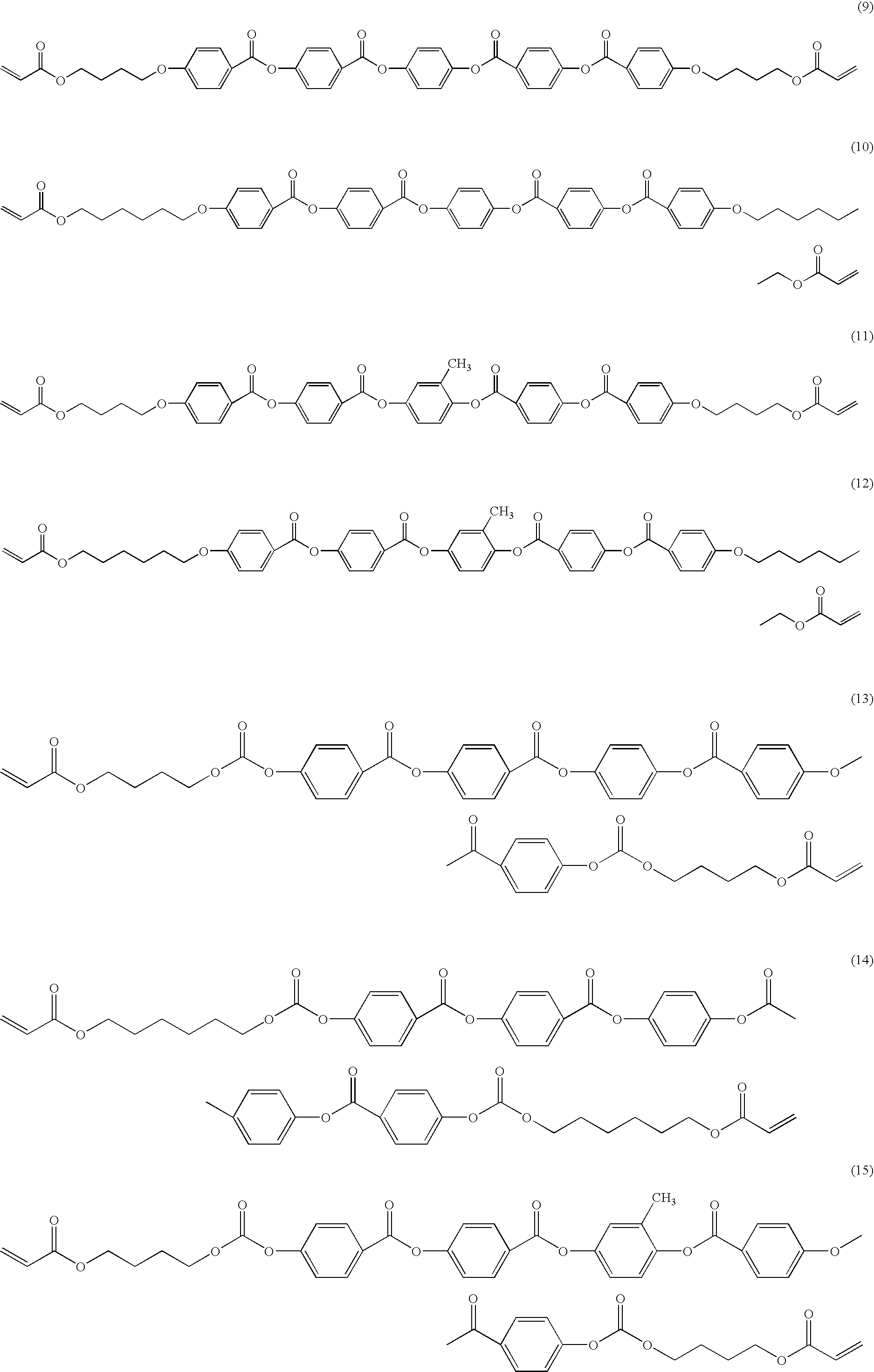

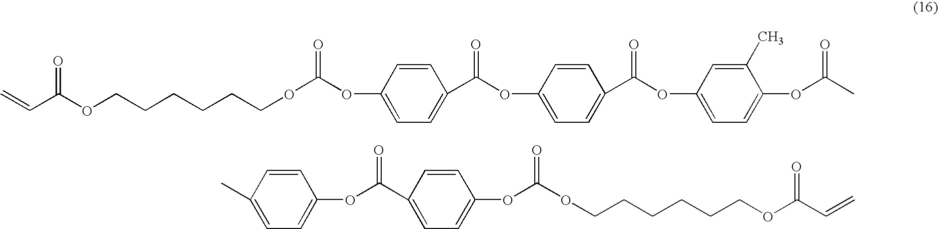

Preferably, the liquid crystal monomer solution contains a polymerization agent or a cross-linking agent. As the polymerization agent and the cross-linking agent, for example, those listed below may be used without particular limitation. As the polymerization agent, for example, benzoyl peroxide (BPO), azobis isobutyronitrile (AIBN) and the like may be used, and as the cross-linking agent, for example, an isocyanate-based cross-linking agent, an epoxy-based cross-linking agent, a metal chelate cross-linking agent and the like may be used. These may be used singly or in combination of two or more kinds.

A coating solution of a liquid crystal monomer solution may be prepared, for example, by dissolving and dispersing the aforementioned liquid crystal monomer in an appropriate solvent. Examples of the solvent include, but are not limited to, halogenated hydrocarbons such as chloroform, dichloromethane, carbon tetrachloride, dichloroethane, tetrachloroethane, methylene chloride, trichloroethylene, tetrachloroethylene, chlorobenzene, and ortho dichlorobenzene; phenols such as phenol, p-chlorophenol, o-chlorophenol, m-cresol, o-cresol and p-cresol; aromatic hydrocarbons such as benzene, toluene, xylene, methoxybenzene, and 1,2-dimethoxybenzene; ketone solvents such as acetone, methylethylketone (MEK), methylisobutyl ketone, cyclohexanone, cyclopentanone, 2-pyrrolidone, and N-methyl-2-pyrrolidone; ester solvents such as ethyl acetate and butyl acetate; alcoholic solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide solvents such as dimethylformamide and dimethylacetamide; nitrile solvents such as acetonitrile and butylonitrile; ether solvents such as diethyl ether, dibutyl ether, tetrahydrofuran, and dioxane; or carbon bisulfide, ethyl cellosolve, butyl cellosolve and the like. Among these, preferred are toluene, xylene, mesitylene, MEK, methyl isobutyl ketone, cyclohexanone, ethyl cellosolve, butyl cellosolve, ethyl acetate, butyl acetate, propyl acetate, and ethyl cellosolve acetate. These solvents may be used, for example, singly or in combination of two or more kinds.

The coating solution may be made to flow and develop, for example, by a conventionally known method such as roll coating method, spin coating method, wire bar coating method, dip coating method, extrusion coating method, curtain coating method, spray coating method and so on, and among these, the spin coating method and the extrusion coating method are preferred from the viewpoint of coating efficiency.

The temperature condition of the heating treatment after application of the coating solution of the liquid crystal monomer solution on a surface of the long plastic film F may be selected appropriately depending on, for example, the kind of the liquid crystal monomer used, concretely depending on the temperature where the liquid crystal monomer shows the liquid crystallinity, which is usually in the range of 40 to 120° C., preferably in the range of 50 to 100° C., and more preferably in the range of 60 to 90° C. Generally, when the temperature is 40° C. or higher, it is possible to make the liquid crystal monomer be oriented sufficiently, whereas when the temperature is 120° C. or lower, for example, selectivity of the long plastic film F is widened in terms of heat resistance.

As the above liquid crystal compound to be dissolved, any compound may be used without particular limitation in so far as it can be used for coating, and for example, rod-like liquid crystal compounds, tabular liquid crystal compounds and polymers thereof may be used. To be more specific, liquid crystal compounds such as azomethines, azoxys, cyanobiphenyls, cyanophenyl esters, benzoic esters, cyclo-hexane carboxylic phenyl esters, cyanophenyl cyclohexanes, cyano-substituted phenyl pyrimidines, alkoxy-substituted phenyl pyrimidines, phenyldioxanes, tolans, and alkenylcyclohexyl benzonitriles, and polymers thereof are preferably used.

The optical film produced by the production method according to the present embodiment described above may be provided with functions such as retardation, color compensation, enlargement of viewing angle, and antireflection by appropriately applying methods known in the art, and may be used as an optical film for a variety of display apparatuses including a liquid crystal display, a plasma display, and an EL display.

### EXAMPLES

In the following, features of the present invention will be made more apparent by way of the example and the comparative example.

### Example

Using the rubbing treatment apparatus 100 as shown in FIGS. 1 and 2A, a rubbing treatment was conducted on a triacetyl cellulose film of 40 μm thick having been subjected to a saponification treatment. Mirror finishing of a surface of the conveyance belt 3 was Ra=0.01 μm, the outer diameter of the driving rolls 1 and 2 was 550 mm, the conveyance speed of the film was 5 m/min, the outer diameter of every backup roll 51 was 90 mm, every center-to-center distance L1 in the rotation axis direction of respective neighboring backup rolls 51 was 80 mm, and a width L2 in the rotation axis direction of every backup roll 51 was 30 mm. Further, the rubbing roll 4 (including the raised fabric 4a) had a radius of 76.89 mm, and was wound with a raised fabric made of rayon. The rotation axis of the rubbing roll 4 was inclined by 24.3° with respect to a conveyance direction of the film, and each backup roll 51 was disposed directly below the rubbing roll 4 and along the straight line that is parallel with the rotation axis of the rubbing roll 4. The rotation speed of the rubbing roll 4 was 1500 rpm, and the pushing amount was 0.3 mm.

### Comparative Example

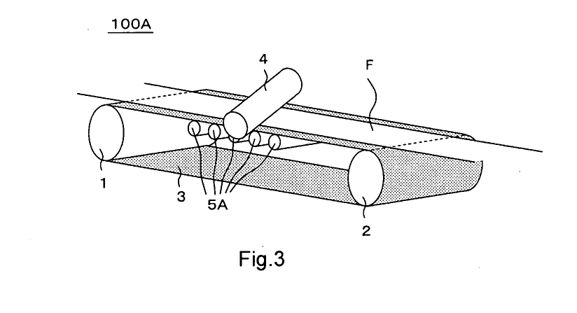

A retardation film was fabricated according to the example except that a rubbing treatment apparatus 100A as shown in FIG. 3 (the configuration in which the bottom face of the conveyance belt 3 is supported by a plurality of (five) rod-like backup rolls 5A arranged approximately parallel with each other and rotating along the conveyance direction of the conveyance belt 3) was used. The outer diameter of every backup roll 5A of the rubbing treatment apparatus 100A was 50 mm, and the axis-to-axis distance of rotation axes of the respective neighboring backup rolls 5A was 80 mm.

### <Evaluation Result>

### (1) Evaluation of Flatness of Conveyance Belt

The flatness of the conveyance belt 3 was evaluated for the rubbing treatment apparatuses of the example and the comparative example. Specifically, the dimension of clearance between the rubbing roll 4 and the conveyance belt 3 was sequentially measured by using a clearance gauge at plural positions along the rotation axis direction of the rubbing roll 4. Also, a difference between the maximum value and the minimum value of clearance measured at the plural positions along the rotation axis direction of the rubbing roll 4 was evaluated as the flatness of the surface of the conveyance belt 3.

The result of the above evaluation revealed that the flatness of the conveyance belt 3 is improved in the rubbing treatment apparatus 100 of the example showing a flatness of 50 μm, in contrast to the rubbing treatment apparatus 100A of the comparative example showing a flatness of 130 μm.

### (2) Evaluation of Appearance of Film

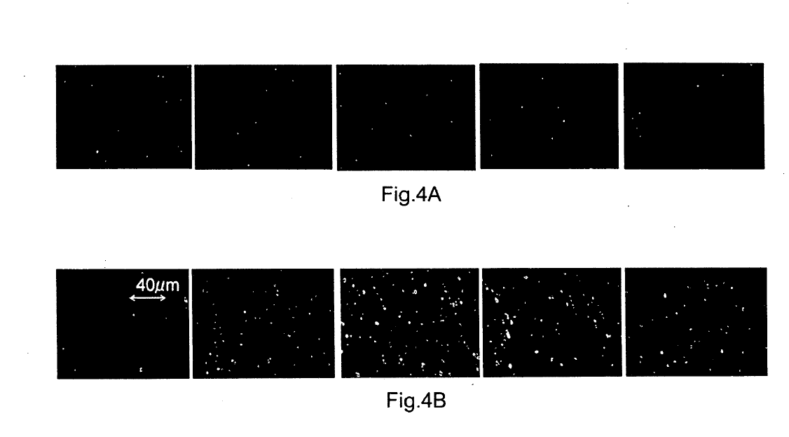

FIGS. 4A and 4B show pictures of appearance of triacetyl cellulose films to which the rubbing treatment is conducted in the example and the comparative example. FIG. 4A shows a picture of appearance of the example, and FIG. 4B shows a picture of appearance of the comparative example. More specifically, each picture of appearance shown in FIGS. 4A and 4B is obtained by imaging a triacetyl cellulose film after rubbing treatment under a laser microscope available from KEYENCE Corporation (Model number: VK-8500), and binarizing the image (monochrome image in 256 shades of gray) at the same binarization level (the values of 151 or higher were assigned to white, and the values of 150 or less were assigned to black in 256 shades of gray) by adobe photoshop which is image processing software. The pictures of appearance shown in FIGS. 4A and 4B are binarized images at positions of 50 mm, 210 mm, 370 mm, 530 mm, and 690 mm from an end in the width direction of the triacetyl cellulose film, respectively, from the left.

As shown in FIG. 4A, the film according to the example had a smaller area of white dots extracted by binarization (corresponding to contaminants adhered to the film) compared to the film according to the comparative example shown in FIG. 4B. This is attributable to the fact that the orientation characteristics of the film according to the example is more uniform than that of the comparative example, and as a result of this, adherence of contaminants is reduced.

1. A method of producing an optical film comprising:
a rubbing treatment step of rubbing a surface of a long plastic film by a rubbing roll having a rotation axis inclined from a perpendicular direction with respect to a conveyance direction of the long plastic film;
an applying step of applying liquid crystalline molecules on the surface of the long plastic film after the rubbing treatment step; and
a fixing step of fixing the applied liquid crystalline molecules,
wherein in the rubbing treatment step, the long plastic film is conveyed while being supported by a conveyance belt having a metal surface, and a backup roll mechanism that supports a bottom face of the conveyance belt supporting the long plastic film is provided,
the backup roll mechanism has a plurality of backup rolls each rotating along the conveyance direction of the conveyance belt, and
each of the plurality of backup rolls is disposed directly below the rubbing roll, along a straight line that is approximately parallel with the rotation axis of the rubbing roll.

2. The method of producing an optical film according to claim 1, wherein
the backup roll mechanism further includes:
a pedestal part disposed along a straight line that is approximately parallel with the rotation axis of the rubbing roll, and
a plurality of supporting parts borne on the pedestal part in a rotatable manner about a normal of a surface of the conveyance belt, and
each of the plurality of backup rolls is borne on each of the plurality of supporting parts in a rotatable manner along the conveyance direction of the conveyance belt.

3. The method of producing an optical film according to claim 2, wherein
the backup roll mechanism further includes:
a coupling mechanism that couples the rubbing roll and the pedestal part, in such a manner that the pedestal part is inclined accordingly when the rotation axis of the rubbing roll is inclined from a perpendicular direction with respect to the conveyance direction of the conveyance belt.

4. The method of producing an optical film according to claim 1, wherein the rotation axis of the rubbing roll is inclined at an angle of more than 0° and not more than 45° with respect to a perpendicular direction of the conveyance direction of the long plastic film.

5. The method of producing an optical film according to claim 1, wherein the plurality of backup rolls are set so that a center-to-center distance in the rotation axis direction of neighboring backup rolls is 60 mm or more and 200 mm or less.

6. The method of producing an optical film according to claim 5, wherein a width in the rotation axis direction of each of the plurality of backup rolls is set at 20 mm or more and 150 mm or less.

7. The method of producing an optical film according to claim 1, wherein the long plastic film is a triacetyl cellulose film.

8. The method of producing an optical film according to claim 7, wherein the triacetyl cellulose film is saponified.

9. The method of producing an optical film according to claim 1, wherein a raised fabric is wound on the rubbing roll.

10. The method of producing an optical film according to claim 9, wherein the raised fabric is any one of rayon, cotton and a mixture thereof.

11. The method of producing an optical film according to claim 1, wherein a thickness of the conveyance belt is 0.5 mm or more and 2.0 mm or less.
